(19) United States
(12) Patent Application Publication
(10) Pub. No.: US 2026/0002740 A1
(43) Pub. Date: Jan. 1, 2026

(54) HEAT EXCHANGER FOR UVO CLEANING SYSTEM

(71) Applicant: KLA CORPORATION, Milpitas, CA (US)

(72) Inventors: Mitchell FAUST, Ann Arbor, MI (US); Tara CHAN, Ann Arbor, MI (US); HongBo SI, Ann Arbor, MI (US); Jason LERCH, Ann Arbor, MI (US); Francis CHILESE, San Ramon, CA (US)

(21) Appl. No.: 18/793,162

(22) Filed: Aug. 2, 2024

Related U.S. Application Data
(60) Provisional application No. 63/665,517, filed on Jun. 28, 2024.

(51) Int. Cl. F28F 9/00; F28F 9/02; F28F 27/02

(52) U.S. Cl. CPC F28F 9/001; F28F 9/0219; F28F 27/02

(57) ABSTRACT

A heat exchanger for a cleaning system includes a housing, and a manifold coupled to and at least partially extending into the housing. The manifold includes a manifold body extending between a first manifold end and a second manifold end, and a manifold channel formed within the manifold body. The heat exchanger further includes a light source operatively coupled to the second manifold end of the manifold, a fluid inlet fluidly coupled to the manifold channel, and a fluid outlet fluidly coupled to the manifold channel. The fluid inlet is positioned to direct a fluid onto the second manifold end of the manifold to cool the light source.

### FIELD OF THE INVENTION

This application claims the benefits of priority to U.S. Provisional Patent Application Ser. No. 63/665,517, filed Jun. 28, 2024, the disclosure of which is incorporated by reference herein in its entirety.

The embodiments described herein relate to ultraviolet-ozone (UVO) cleaning processes and, more particularly, to a heat exchanger used in UVO cleaning processes.

### BACKGROUND

UVO cleaning systems are utilized in semiconductor manufacturing for their ability to remove organic contaminants and/or carbon buildup from optical components, such as mirrors and lenses. In particular, these UVO cleaning systems generate ozone through the exposure of oxygen to ultraviolet (UV) light, with the ozone reacting with organic contaminants to allow the contaminants to be easily removed from surfaces of the optical components.

Traditional UVO cleaning systems utilize vapor lamps and/or lasers to produce UV light. Although effective, these light sources produce significant amounts of heat, which necessitate bulky cooling systems to prevent overheating. Furthermore, the size of these traditional UV light sources and their associated cooling systems poses challenges in integration, particularly within systems with stringent spatial constraints. Accordingly, a need exists for a UVO cleaning system including a heat exchanger that efficiently transfers heat from UV light sources while fitting within the tight spatial constraints of the system.

### SUMMARY OF THE DISCLOSURE

Embodiments described herein relate to a heat exchanger for a cleaning system. The heat exchanger includes a housing, and a manifold coupled to and at least partially extending into the housing. The manifold includes a manifold body extending between a first manifold end and a second manifold end, and a manifold channel formed within the manifold body. The heat exchanger further includes a light source operatively coupled to the second manifold end of the manifold, a fluid inlet fluidly coupled to the manifold channel, and a fluid outlet fluidly coupled to the manifold channel. The fluid inlet is positioned to direct a fluid onto the second manifold end of the manifold to cool the light source.

In other embodiments of the present disclosure, a cleaning system is disclosed. The cleaning system comprises a chamber including a plurality of optical components, and a heat exchanger coupled to the chamber. The heat exchanger includes a housing, and a manifold coupled to and at least partially extending into the housing. The manifold includes a manifold body extending between a first manifold end and a second manifold end, and a manifold channel formed within the manifold body. The heat exchanger further includes a light source operatively coupled to the second manifold end of the manifold, such that the light source directs a light onto at least one of the plurality of optical components of the chamber, a fluid inlet fluidly coupled to the manifold channel, and a fluid outlet fluidly coupled to the manifold channel. The fluid inlet is positioned to direct a fluid onto the second manifold end of the manifold to cool the light source.

In yet another embodiment, a method of cooling a light source of a heat exchanger for a cleaning system is disclosed. The method includes directing a fluid through a fluid inlet fluidly coupled to a manifold of the heat exchanger; expelling the fluid from the fluid inlet and onto a second manifold end of the manifold on which the light source is coupled; generating an impingement cooling zone on the second manifold end of the manifold to cool the light source; directing the fluid through a manifold channel formed in the manifold; generating an annular convection zone within the manifold channel to cool the light source; and flushing the fluid from the heat exchanger via a fluid outlet fluidly coupled to the manifold

These aspects and other advantages and features are apparent from the following description taken in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a UVO cleaning system, according to one or more embodiments shown and described herein;

FIG. 2A is a partial cross-sectional view of the UVO cleaning system of FIG. 1, according to one or more embodiments shown and described herein;

FIG. 2B is a perspective view of a heat exchanger integrated into the UVO cleaning system of FIG. 1, according to one or more embodiments shown and described herein;

FIG. 3 is a perspective view of the heat exchanger of FIG. 2B, according to one or more embodiments shown and described herein;

FIG. 4 is a cross-sectional view of the heat exchanger of FIG. 3, according to one or more embodiments shown and described herein;

FIG. 5 is a cross-sectional view of a manifold of the heat exchanger of FIG. 3, according to one or more embodiments shown and described herein;

FIGS. 6A-6C are partial cross-sectional views of embodiments of the heat exchanger of FIG. 3, according to one or more embodiments shown and described herein;

FIG. 7A is a partial cross-sectional view of the heat exchanger of FIG. 3, according to one or more embodiments shown and described herein;

FIG. 7B is a partial top-side perspective view of the heat exchanger of FIG. 3, according to one or more embodiments shown and described herein; and

FIG. 8 is an illustrative flow diagram of a method of cooling a light source of a heat exchanger for a cleaning system, according to one or more embodiments shown and described herein.

### DETAILED DESCRIPTION

Embodiments disclosed herein relate to a heat exchanger for a UVO cleaning system. The heat exchanger includes a housing and a manifold coupled to and at least partially extending into the housing. The manifold further includes a manifold body extending between a first manifold end and a second manifold end, and a manifold channel formed within the manifold body. A light source is fixedly coupled to the second manifold end of the manifold, a fluid inlet is fluidly coupled to the manifold channel, and a fluid outlet fluidly is coupled to the manifold channel. The fluid inlet is positioned to direct a fluid onto the second manifold end of the manifold to generate an impingement zone configured to cool the light source. In these embodiments, as fluid contacts the second manifold end and generates the impingement zone, the fluid may radially expand and traverse the manifold channel. As the fluid traverses the manifold channel, the fluid may continue to provide cooling effects via annular convection across a length of the manifold channel. Accordingly, the heat exchanger described herein may provide both impingement and annular convection cooling in order to increase the thermal efficiency of the heat exchanger.

As should be appreciated, UVO cleaning systems are commonly utilized in semiconductor manufacturing to remove carbon buildup and other contaminants from the surface of optical components, such as mirrors and lenses. These traditional UVO cleaning systems operate by generating ozone through the exposure of ultraviolet light. The generated ozone then reacts with carbon and/or other contaminants in order to break down the contaminants into compounds that may be easily removed from the optical components.

As described herein, traditional UVO cleaning systems utilize vapor (e.g., mercury vapor, etc.) lamps and/or lasers as UV light sources. However, these UV light sources generate significant amount of heat, thereby necessitating the implementation of complex and bulky cooling systems into the UVO cleaning system in order to prevent overheating of the light source. Furthermore, these light sources and their respective cooling systems may be difficult to integrate into UVO cleaning systems due to the spatial constraints of traditional systems.

Furthermore, vapor lamps and/or laser UV light sources may provide limited efficiency and operational lifetime, which may lead to frequent replacement of the light source and increased maintenance costs. In some instances, the use of vapor lamps, such as mercury vapor lamps, may also raise environmental and/or health concerns due to the hazardous nature of the vapors utilized.

The disclosed UVO cleaning system aims to resolve these issues by utilizing a light source and heat exchanger that provide higher energy efficiency, longer operational lifetimes, and a more compact form factor. In particular, the UVO cleaning system described herein may include a heat exchanger that leverages impinging flow liquid cooling to enhance heat transfer from a light source in the UVO cleaning system, which may aid in preventing the light source from overheating. Furthermore, the cooling efficiency of the heat exchanger may allow for the heat exchanger to be compact in design, such that the heat exchanger may be more easily integrated into existing UVO cleaning systems.

Embodiments of UVO cleaning systems, heat exchangers, and methods of cooling UV light sources will now be described in additional detail herein. The following will now describe these UVO cooling systems, heat exchangers, and methods in more detail with reference to the drawings and where like numbers refer to like structures.

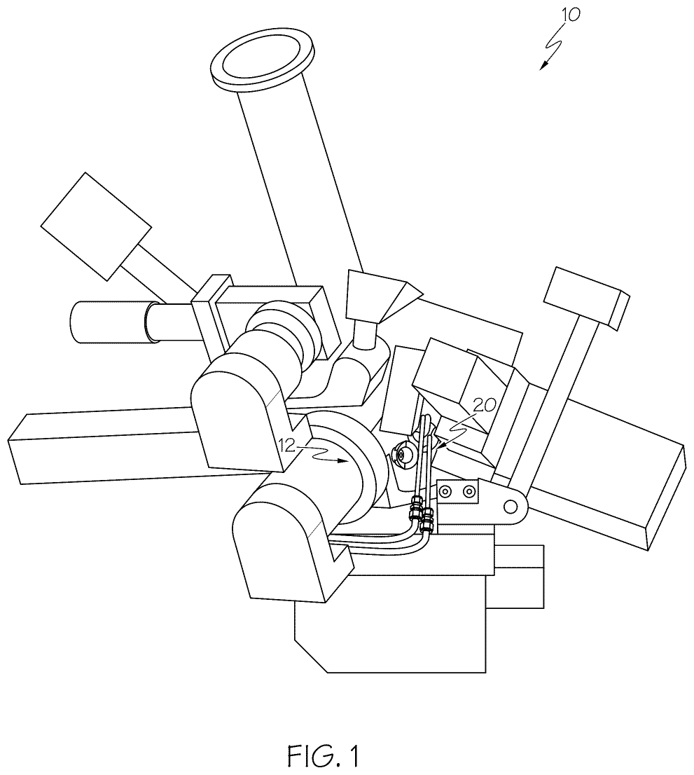

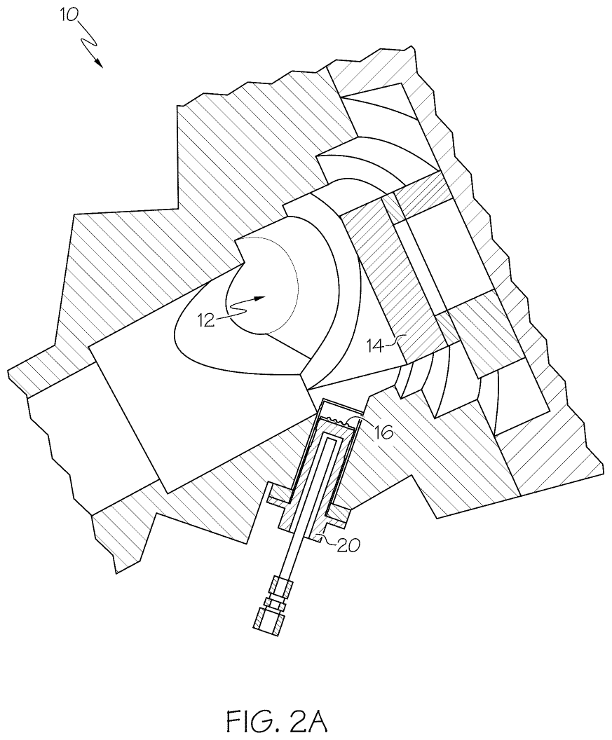

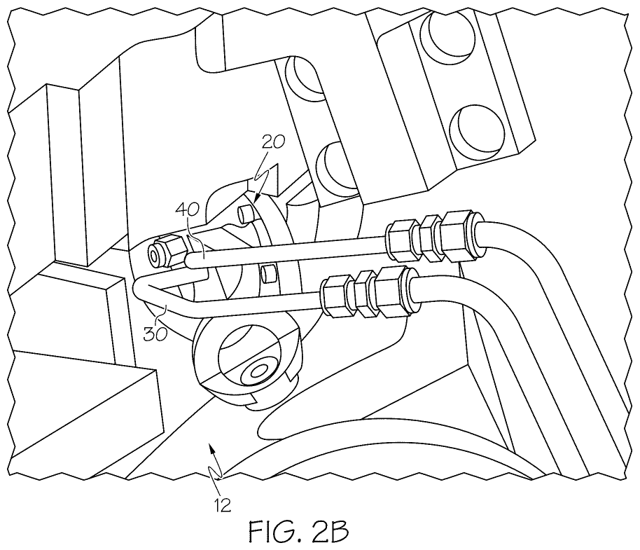

Referring now to FIGS. 1-2B, a cleaning system 10, such as a UVO cleaning system, is depicted. In these embodiments, the cleaning system 10 may include a chamber 12 that houses a plurality of optical components 14, such as mirrors, which may be cleaned via the cleaning system 10 described herein. In these embodiments, the light source 16 may be housed within a heat exchanger 20, which may be configured to cool the light source 16 during operation of the cleaning system 10 to prevent overheating of the light source 16. Although the cleaning system 10 depicted in FIGS. 1-2B is illustrated as including a light source 16, it should be further appreciated that, in some embodiments, the cleaning system 10 may further include any heat source without departing from the scope of the present disclosure.

In the embodiments described herein, the light source 16 may be a light emitting diode (LED) configured to generate UV light within the chamber 12. In these embodiments, the UV light generated by the light source 16 may interact with oxygen within the chamber 12 to form ozone, which may break down contaminants, such as carbon, that accumulate on surfaces of the plurality of optical components 14. Once the contaminants are broken down (e.g., into simpler molecules such as carbon dioxide and water), the contaminants may be removed from the surfaces of the plurality of optical components 14.

It should be appreciated that, in the embodiments described herein, the use of a LED as light source 16 may provide higher luminous efficacy compared to traditional light sources, while also reducing heat generation. Furthermore, the compactness of LEDs may allow for the light source 16 to be more easily integrated into the chamber 12 of the cleaning system 10. Accordingly, by reducing the form factor and heat generation of the light source 16, the burden on the heat exchanger 20 may be reduced, thereby allowing for a more compact and efficient heat exchanger to be utilized to manage the thermal load of the light source 16.

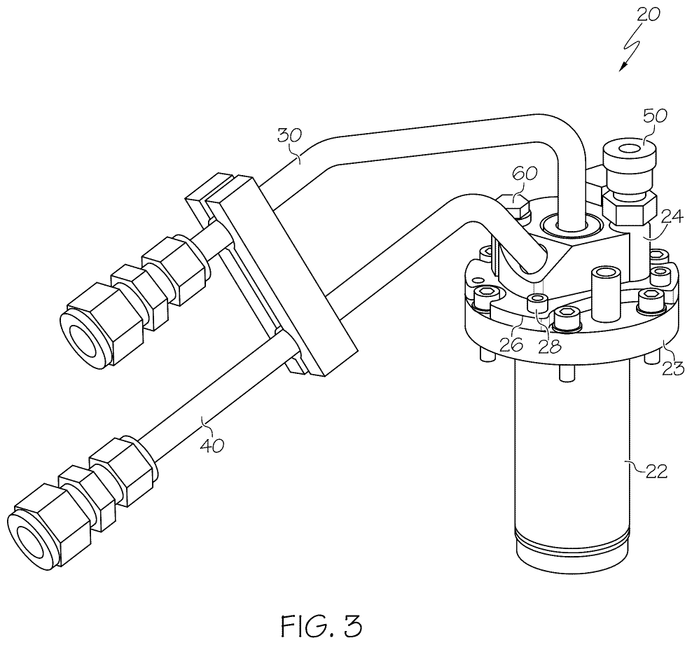

As depicted most clearly in FIGS. 2A and 2B, the light source 16 and heat exchanger 20 in which the light source 16 is housed may be integrated into the chamber 12 and oriented such that light emitted from the light source 16 is directed onto the surface of at least one of the plurality of optical components 14. As illustrated in FIG. 2B, the heat exchanger 20 may further include a fluid inlet 30 and fluid outlet 40, such that the heat exchanger 20 may be configured to utilize liquid cooling to dissipate heat from the light source 16 during operation of the cleaning system 10. For example, in these embodiments, the fluid inlet 30 and the fluid outlet 40 may fluidly couple the heat exchanger 20 to a reservoir chamber, pump, or other fluid source, such that fluid may circulate through the heat exchanger 20 and cool the light source 16. Operation of the heat exchanger 20 will be described in additional detail herein with reference to FIGS. 3-7B.

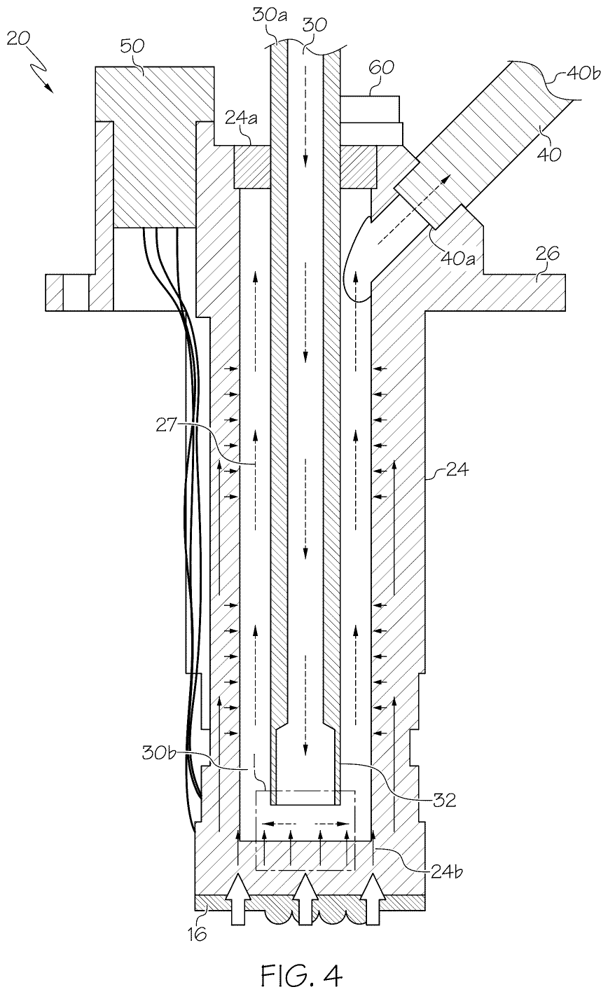

Turning now to FIGS. 3 and 4, the heat exchanger 20 is depicted in additional detail. In these embodiments, the heat exchanger 20 may include a housing 22 and a manifold 24 that extends into and is received by the housing 22. As illustrated most clearly in FIG. 4, the manifold 24 may extend between a first manifold end 24a and a second manifold end 24b, and a plurality of flanges 26 may extend radially outward from the first manifold end 24a of the manifold 24. In these embodiments the plurality of flanges 26 may be coupled to a rim 23 formed on the housing 22, such that a seal is formed between the housing 22 and the manifold 24. For example, as illustrated most clearly in FIG. 3, a plurality of fasteners 28 may extend through the plurality of flanges 26 and into or through the rim 23 of the housing 22 to fixedly couple the housing 22 to the manifold 24. In these embodiments, a plurality of scaling mechanisms (not depicted), such as gaskets, O-rings, or any other similar sealing mechanism may be positioned between the plurality of flanges 26 and the rim 23 to further aid in forming a seal between the housing 22 and the manifold 24 when the housing 22 is coupled to the manifold 24.

Although the housing 22 and manifold 24 are depicted as being coupled via the plurality of fasteners 28, it should be appreciated that the manifold 24 and housing 22 may be joined via any suitable coupling capable of forming a seal between the manifold 24 and housing 22. For example, in some embodiments, the plurality of flanges 26 of the manifold 24 and/or the rim 23 of the housing 22 may include a threaded interface allowing for the manifold 24 and the housing 22 to be screwed together. Furthermore, in some embodiments, the housing 22 and the manifold 24 may be joined via an adhesive, such as a thermal paste or pad capable of bonding the housing 22 to the manifold 24 while withstanding the thermal load of the heat exchanger 20.

Referring still to FIGS. 3 and 4, the fluid inlet 30 and the fluid outlet 40 may be fluidly coupled to the first manifold end 24a of the manifold 24, such that fluid may circulate within the manifold 24 and dissipate heat from the light source 16. For example, in these embodiments, fluid may enter the manifold 24 via the fluid inlet 30, circulate throughout the manifold 24, and exit the manifold 24 via the fluid outlet 40. Circulation of fluid through the manifold 24 will be described in additional detail herein with reference to FIG. 4.

As further depicted in FIGS. 3 and 4, the heat exchanger 20 may further include a gas inlet 50 and a gas outlet 60. In these embodiments, the gas inlet 50 may be a quick-connect fitting, such as a vacuum fitting, while the gas outlet 60 may include a filter 62, such as a sinter filter. In the embodiments described herein, gas may be passed between the gas inlet 50 and the gas outlet 60 to purge an external environment around the manifold 24 and light source 16 of the heat exchanger 20, as will be described in additional detail herein. Although the heat exchanger depicted in FIGS. 3 and 4 is illustrated as including the filter 62, it should be appreciated that the gas outlet 60 may include any mechanism configured to block light and allow gas flow without departing from the scope of the present disclosure. For example, in some embodiments, the gas outlet 60 may further include a light-tight outlet that includes a perpendicular relief valve configured to block the passage of light from the gas outlet while allowing for the flow of gas from the gas outlet 60.

Turning now to FIG. 4, the manifold 24 of the heat exchanger 20 is depicted in additional detail. As illustrated in FIG. 4, the manifold 24 may further include a manifold body 25 that extends between the first manifold end 24a and the second manifold end 24b. In these embodiments, the manifold 24 may further define a manifold channel 27, which may be formed within the manifold body 25 and extend at least partially between the first manifold end 24a and the second manifold end 24b.

As further depicted in FIG. 4, the fluid inlet 30 and fluid outlet 40 may be fluidly coupled to the manifold channel 27. For example, in these embodiments, the fluid inlet 30 may include a fluid inlet proximal end 30a and a fluid inlet distal end 30b opposite the fluid inlet proximal end 30a, while the fluid outlet 40 may include a fluid outlet proximal end 40a and a fluid outlet distal end 40b positioned opposite the fluid outlet proximal end 40a. As illustrated in FIG. 4, the fluid inlet 30 may extend into the manifold channel 27, such that the fluid inlet distal end 30b is in fluid communication with the manifold channel 27. Accordingly, it should be appreciated that fluid supplied to the fluid inlet 30 may enter and/or traverse the manifold channel 27 prior to exiting the fluid outlet 40, as will be described in additional detail herein.

Referring still to FIG. 4, the light source 16 may be fixedly coupled to the second manifold end 24b of the manifold 24. In these embodiments, the light source 16 may be fixedly coupled to the second manifold end 24b of the manifold 24 via any suitable coupling means, such as a mechanical, thermal, and/or electrical coupling. For example, in some embodiments, the heat exchanger 20 may further include a mounting bracket (not depicted), or other similar fastening means configured to fixedly couple the light source 16 to the heat exchanger. In other embodiments, the light source 16 may be bonded to the second manifold end 24b via an adhesive, such as a thermal pad or paste, or any other similar adhesive configured to secure the light source 16 to the second manifold end 24b while withstanding the heat generated by the light source 16 during operation of the UVO cleaning system 10. In other embodiments still, the light source 16 and second manifold end 24b may be electrically coupled, such as via soldered joints or any other similar coupling.

Operation of the heat exchanger 20 will now be described herein with reference to FIG. 4. Initially, it should be appreciated that fluid, such as coolant (e.g., water, etc.), may be supplied to the heat exchanger 20 via the fluid inlet 30. In these embodiments, fluid may be expelled from the fluid inlet distal end 30b such that the fluid directly contacts the second manifold end 24b of the manifold 24, on which the light source 16 is coupled. Accordingly, the direction of the fluid from the fluid inlet distal end 30b and onto the second manifold end 24b may generate an impingement cooling zone I, in which contact between the fluid and the second manifold end 24b (and in turn the light source 16) results in enhanced cooling due to the direct contact between the fluid and the second manifold end 24b.

Referring still to FIG. 4, as the fluid is expelled from the fluid inlet distal end 30b and impinges (e.g., contacts) the second manifold end 24b on which the light source 16 is mounted, the fluid may spread radially outward, such that the fluid is guided through the manifold channel 27 (e.g., on either side of the fluid inlet 30). In these embodiments, as the fluid traverses the manifold channel 27, the fluid may further enhance cooling efficiency of the heat exchanger 20 prior to exiting the heat exchanger 20 via the fluid outlet 40. For example, as the fluid traverses the manifold channel 27, the fluid may continue to provide annular convection of heat from the light source 16 prior to being directed out of the fluid outlet 40. In these embodiments, it should be appreciated that the manifold channel 27 may have a channel thickness that is sufficiently wide to allow heat to transfer through the manifold channel, such that heat does not become trapped within the impinging zone I near the light source 16. It should be appreciated that, as the fluid exits the fluid outlet 40, heat absorbed by the fluid from the light source 16 (e.g., via impingement and annular convection) may be removed from the heat exchanger 20, which may aid in ensuring efficient and uniform cooling of the system.

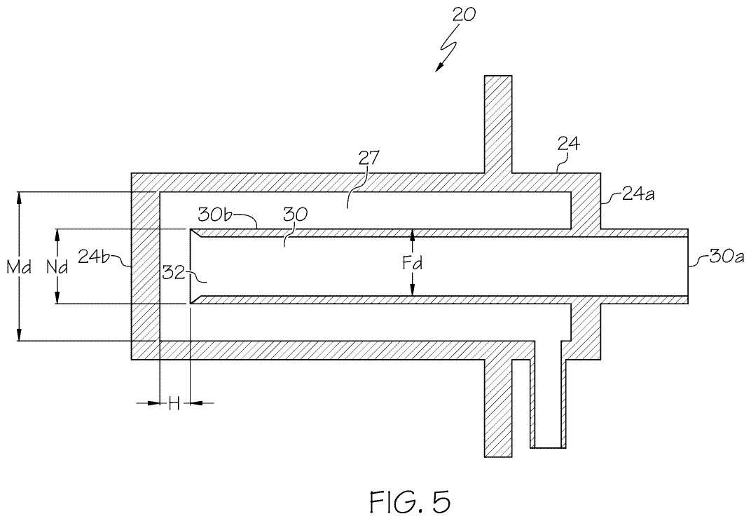

Turning now to FIG. 5, it should be appreciated that various operational parameters of the components of the heat exchanger 20 may impact the rate of heat transfer of the heat exchanger 20. For example, as illustrated in FIG. 5, the fluid inlet 30 may include a fluid inlet diameter Fd, the manifold channel may include a manifold channel diameter Md, and the fluid inlet distal end 30b may be spaced from the second manifold end 24b by a distance H. In the embodiments described herein, altering the fluid inlet diameter Fd, the manifold channel diameter Md, and/or the distance H may impact the heat transfer properties of the heat exchanger 20.

For example, decreasing the fluid inlet diameter Fd of the fluid inlet 30 may increase the velocity of the fluid expelled from the fluid inlet 30, which is directed onto the second manifold end 24b to generate the impingement zone I. Accordingly, it should be appreciated that a higher fluid velocity may enhance heat transfer within the impingement zone I, while increasing the fluid inlet diameter Fd (e.g., decreasing the fluid velocity) may reduce heat transfer within the impingement zone I. Conversely, decreasing the fluid inlet diameter Fd may increase a pressure drop across the fluid inlet 30. While the higher pressure drop across the fluid inlet 30 may increase fluid velocity and cooling efficiency of the heat exchanger 20, particularly within the impingement zone I, maintaining such a high fluid velocity may result in increased energy consumption across the cleaning system 10.

As further depicted in FIG. 5, the fluid inlet distal end 30b may include a nozzle 32, which may be configured to direct the fluid that passes through the fluid inlet 30 onto the second manifold end 24b. In these embodiments, the nozzle 32 may have a nozzle diameter Nd that increases along a length of the nozzle diameter Nd. Accordingly, as the nozzle diameter Nd increases, the velocity of the fluid exiting the nozzle 32 may decrease prior to being ejected from the fluid inlet 30.

Referring still to FIG. 5, the distance H between the fluid inlet distal end 30b, or nozzle 32, and the second manifold end 24b may similarly impact heat transfer within the heat exchanger 20. For example, decreasing the distance H may result in a higher fluid velocity of the fluid when the fluid contacts the second manifold end 24b, which may yield a stronger impingement effect. However, in some embodiments, decreasing the distance H beyond a predetermined distance threshold may result in fluid stagnation and inadequate radial expansion of the fluid, which may reduce cooling performance. In the embodiments described herein, it may be possible to determine an appropriate distance H between the nozzle 32 and the second manifold end 24b by comparing a ratio of the distance H and the fluid inlet diameter Fd to the flow rate of the fluid passing through the fluid inlet. For example, the ratio of the distance H to the fluid inlet diameter Fd may be between 0.1-1.0, or more particularly, between 0.1-0.3, 0.3-0.5, or 0.5-1.0, as may be determined based on the flow rate of the fluid traversing the fluid inlet 30.

In the embodiments described herein, it should be further appreciated that the ratio between the manifold channel diameter Md and the nozzle diameter Nd may similarly impact fluid velocity, pressure distribution, and heat transfer efficiency within the heat exchanger 20. For example, decreasing the nozzle diameter Nd relative the manifold channel diameter Md may increase the fluid velocity of the fluid exiting the fluid inlet 30, which may in turn increase the pressure drop between the fluid inlet 30 and the manifold channel 27. In these embodiments, the ratio of the manifold channel diameter Md to the nozzle diameter Nd may be determined based on the flow rate of the fluid traversing the fluid inlet 30. For example, in some embodiments, the ratio of the manifold channel diameter Md to the nozzle diameter Nd may be between 1.0-2.5, or more particularly, between 1.0-1.5, 1.5-2.0, or 2.0-2.5.

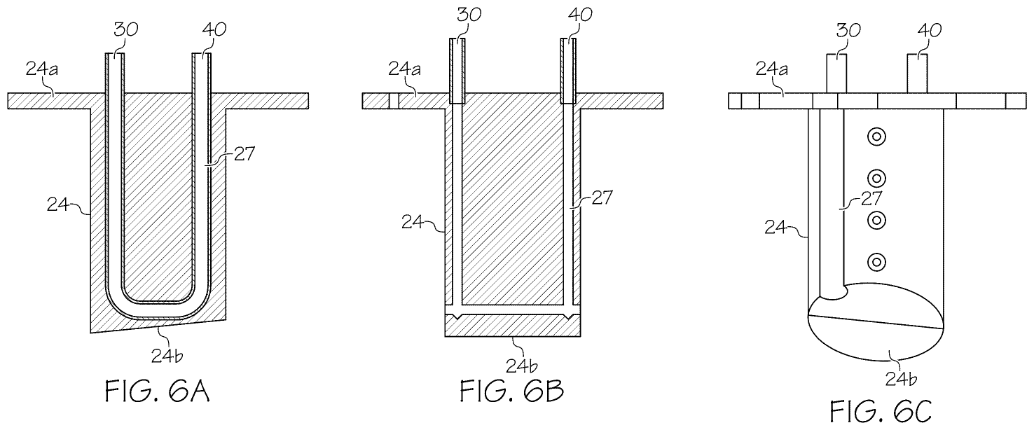

Referring now to FIGS. 6A-6C, additional embodiments of the manifold 24 of the heat exchanger 20 are depicted. In these embodiments, the fluid inlet 30 may be fluidly coupled to the manifold channel 27 at a location that is not adjacent the second manifold end 24b. Accordingly, in these embodiments, the heat exchanger 20 may cool the light source 16 by directing the fluid through the manifold channel 27, as opposed to directing the fluid into direct contact with the second manifold end 24b. As a result, in the embodiments depicted in FIGS. 6A-6C, heat transfer may occur within the manifold channel 27 primarily via convection, rather than impingement.

It should be appreciated that the manifold channel cooling depicted in FIGS. 6A-6C may provide a more uniform cooling across a length of the manifold channel 27, which may be beneficial to cooling evenly distributed heat loads. However, utilizing channel cooling may require longer channels and/or higher fluid flow rates to achieve the same cooling effect that may be possible via impingement cooling. Accordingly, implementation of the channel cooling depicted in FIGS. 6A-6C may be dependent on the spatial constraints of the UVO cleaning system 10 and the thermal load generated by the light source 16.

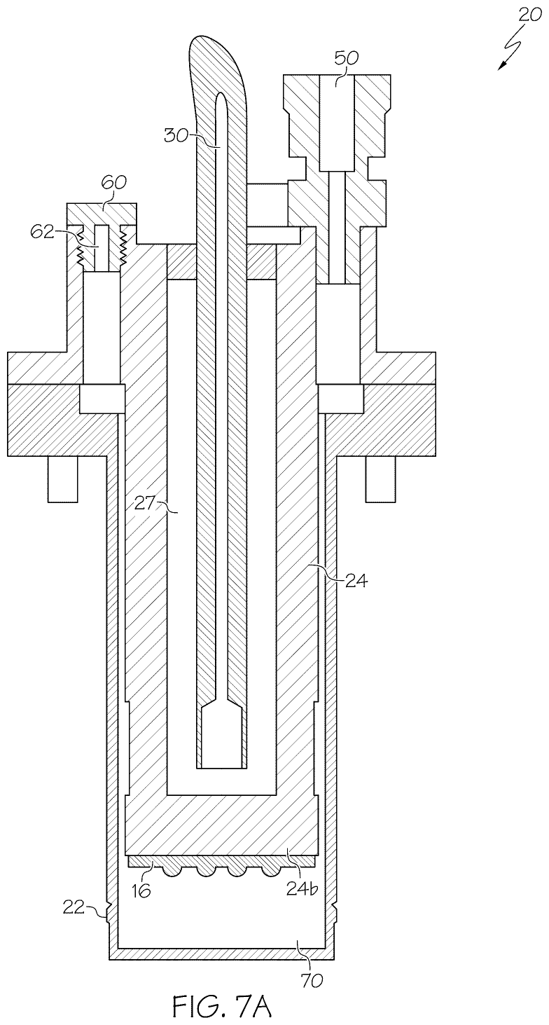

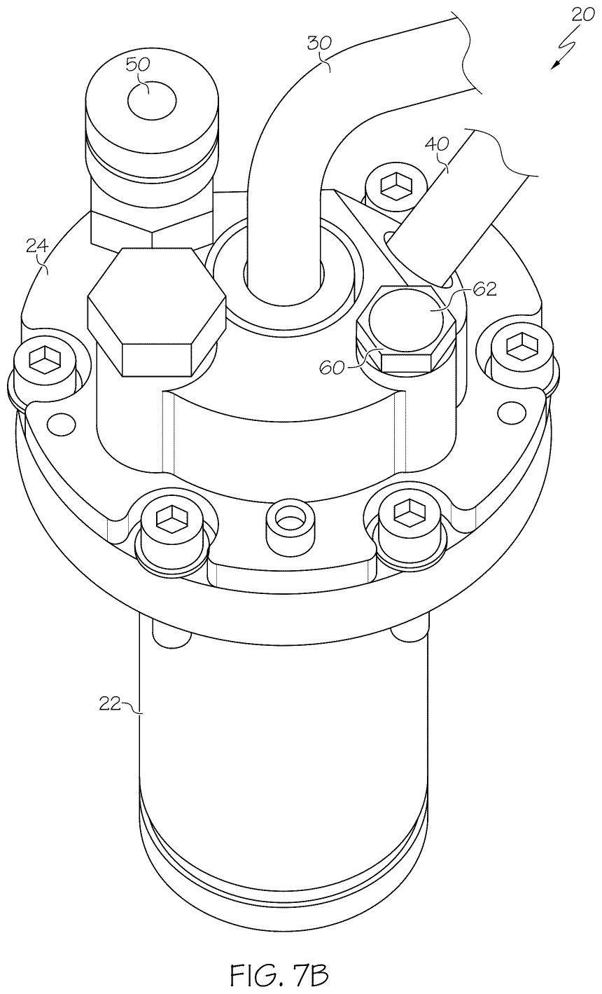

Turning now to FIGS. 7A and 7B, the heat exchanger 20 is depicted in additional detail. For example, as illustrated most clearly in FIG. 7A, and has been described herein within reference to FIGS. 1-4, the heat exchanger 20 includes the manifold 24 received within the housing 22. In these embodiments, when the manifold 24 and housing 22 are coupled together, as has been described in detail herein, the housing 22 may define a cavity 70 that extends between an interior surface of the housing 22, the light source 16, and the manifold 24.

In the embodiments described herein, the housing 22 may be coupled to the manifold 24 such that the cavity 70 is vacuum sealed. In these embodiments, the gas inlet 50 and the gas outlet 60 may be coupled to the cavity 70, such that an inert gas, such as nitrogen, may be circulated from the gas inlet 50, through the cavity 70, and out the gas outlet 60 to ensure that any air and/or contaminants within the cavity 70 are displaced, which may aid in enhancing the integrity of the vacuum formed within the cavity 70.

Referring still to FIGS. 7A and 7B, the gas outlet 60 may further include a filter 62, such as a sintered filter. In these embodiments, the filter 62 may be configured to allow gas to escape the cavity 70 via the gas outlet 60 while preventing light from escaping the cavity 70. Accordingly, it may be possible to ensure that light generated by the light source 16 is directed on the plurality of optical components and does not leak from the heat exchanger 20 via the gas outlet 60.

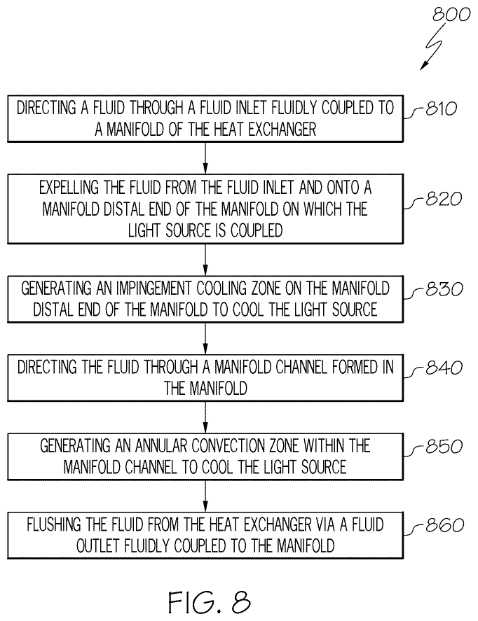

Turning now to FIG. 8, an illustrative flow diagram of a method 800 of cooling a light source of a heat exchanger for a cleaning device is depicted. In these embodiments, the method may begin at block 810, which may involve directing a fluid through a fluid inlet fluidly coupled to a manifold of the heat exchanger. As the fluid is directed into the fluid inlet, the method may advance to block 820, which may involve expelling the fluid form the fluid inlet and onto a second manifold end of the manifold, on which the light source may be coupled. In these embodiments, the fluid inlet may further include a nozzle which may be used to control a flow rate of the fluid when the fluid is expelled from the fluid inlet and directed onto the second manifold end of the manifold.

Referring still to FIG. 8, the method may further involve generating an impingement cooling zone on the second manifold end of the manifold to cool the light source, as illustrated at block 830. In these embodiments, contact between the fluid and the second manifold end may act to generate the impingement cooling zone, in which the fluid may draw heat from the light source (and through the second manifold end) to cool the light source. In these embodiments, it should be appreciated that the fluid inlet may be positioned a distance from the second manifold end, and adjusting the distance between the fluid inlet and the second manifold end may impact the size and/or heat transfer efficiency of the impingement cooling zone.

As further illustrated in FIG. 8, once the fluid contacts the second manifold end and generates the impingement cooling zone, the method may advance to block 840, which may involve directing the fluid through a manifold channel formed in the manifold. In these embodiments, directing the fluid through the manifold channel may further involve generating an annular convection cooling zone within the manifold, which may be used to provide additional cooling benefits to the light source, as shown at block 850. In the embodiments described herein, once the fluid has traversed the impingement cooling zone and the annular convection zone, the method may advance to block 860, which may involve flushing the fluid from the heat exchanger via a fluid outlet fluidly coupled to the manifold. It should be appreciated that, in these embodiments, the fluid may absorb heat from the light source as the fluid traverses both the impingement cooling zone and the annular convection cooling zone, such that flushing the fluid from the heat exchanger via the fluid outlet may act to remove heat absorbed by the fluid from the heat exchanger.

In view of the foregoing, it should be appreciated that the embodiments described herein are related to a cleaning system and a heat exchanger for a cleaning system. The heat exchanger includes a housing and a manifold coupled to and at least partially extending into the housing. The manifold further includes a manifold body extending between a first manifold end and a second manifold end, and a manifold channel formed within the manifold body. A light source is fixedly coupled to the second manifold end of the manifold, a fluid inlet is fluidly coupled to the manifold channel, and a fluid outlet fluidly is coupled to the manifold channel. The fluid inlet is positioned to direct a fluid onto the second manifold end of the manifold to generate an impingement zone configured to cool the light source. In these embodiments, as fluid contacts the second manifold end and generates the impingement zone, the fluid may radially expand and traverse the manifold channel. As the fluid traverses the manifold channel, the fluid may continue to provide cooling effects via annular convection across a length of the manifold channel. Accordingly, the heat exchanger described herein may provide both impingement and annular convection cooling in order to increase the thermal efficiency of the heat exchanger.

The embodiments disclosed herein may be further described with reference to the following aspects:
According to one aspect of the disclosure, and potentially in combination with other disclosed aspects of the disclosure, a heat exchanger comprises: a housing; a manifold coupled to and at least partially extending into the housing, the manifold further comprising: a manifold body extending between a first manifold end and a second manifold end; and a manifold channel formed within the manifold body; a light source fixedly coupled to the second manifold end of the manifold; a fluid inlet fluidly coupled to the manifold channel; and a fluid outlet fluidly coupled to the manifold channel; wherein the fluid inlet is positioned to direct a fluid onto the second manifold end of the manifold to generate an impingement zone configured to cool the light source.
According to one aspect of the disclosure, and potentially in combination with other disclosed aspects of the disclosure, the light source is a light emitting diode.
According to one aspect of the disclosure, and potentially in combination with other disclosed aspects of the disclosure, a plurality of flanges extend radially outward from the first manifold end of the manifold.
According to one aspect of the disclosure, and potentially in combination with other disclosed aspects of the disclosure, a rim is formed on the housing.
According to one aspect of the disclosure, and potentially in combination with other disclosed aspects of the disclosure, a plurality of fasteners extend through the plurality of flanges of the manifold and the rim of the housing to form a seal between the housing and the manifold.
According to one aspect of the disclosure, and potentially in combination with other disclosed aspects of the disclosure, a gas inlet is fluidly coupled to the housing and a gas outlet fluidly coupled to the housing, such that a gas may be passed through a cavity formed between the housing and the manifold.
According to one aspect of the disclosure, and potentially in combination with other disclosed aspects of the disclosure, the gas inlet is a vacuum fitting.
According to one aspect of the disclosure, and potentially in combination with other disclosed aspects of the disclosure, the gas outlet includes a sinter filter.
According to one aspect of the disclosure, and potentially in combination with other disclosed aspects of the disclosure, the fluid is directed onto the second manifold end of the manifold further traverses the manifold channel to generate an annular convection zone to cool the light source.
According to one aspect of the disclosure, and potentially in combination with other disclosed aspects of the disclosure, the fluid inlet further includes a nozzle that directs fluid onto the second manifold end of the manifold.
According to one aspect of the disclosure, and potentially in combination with other disclosed aspects of the disclosure, the fluid inlet includes a fluid inlet diameter and the manifold channel includes a manifold channel diameter, and a ratio of the manifold channel diameter to the fluid inlet diameter is between 1.0-2.5.
According to one aspect of the disclosure, and potentially in combination with other disclosed aspects of the disclosure, the fluid inlet includes a fluid inlet diameter and the fluid inlet is positioned a distance from the second manifold end, and a ratio of the distance to the fluid inlet diameter is between 0.1-1.0.
According to one aspect of the disclosure, and potentially in combination with other disclosed aspects of the disclosure, a cleaning system comprises a chamber including a plurality of optical components; a heat exchanger coupled to the chamber, the heat exchanger comprising: a housing; a manifold coupled to and at least partially extending into the housing, the manifold further comprising: a manifold body extending between a first manifold end and a second manifold end; and a manifold channel formed within the manifold body; a light source fixedly coupled to the second manifold end of the manifold, such that the light source directs a light onto at least one of the plurality of optical components of the chamber; a fluid inlet fluidly coupled to the manifold channel; and a fluid outlet fluidly coupled to the manifold channel; wherein the fluid inlet is positioned to direct a fluid onto the second manifold end of the manifold to cool the light source.
According to one aspect of the disclosure, and potentially in combination with other disclosed aspects of the disclosure, the fluid inlet includes a fluid inlet diameter and the manifold channel includes a manifold channel diameter, and a ratio of the manifold channel diameter to the fluid inlet diameter is between 1.0-2.5.
According to one aspect of the disclosure, and potentially in combination with other disclosed aspects of the disclosure, the fluid inlet includes a fluid inlet diameter and the fluid inlet is positioned a distance from the second manifold end, and a ratio of the distance to the fluid inlet diameter is between 0.1-1.0.
According to one aspect of the disclosure, and potentially in combination with other disclosed aspects of the disclosure, the fluid is directed onto the second manifold end of the manifold further traverses the manifold channel to generate an annular convection zone to cool the light source.
According to one aspect of the disclosure, and potentially in combination with other disclosed aspects of the disclosure, the light source is a light emitting diode.
According to one aspect of the disclosure, and potentially in combination with other disclosed aspects of the disclosure, a gas inlet is fluidly coupled to the housing and a gas outlet fluidly coupled to the housing, such that a gas may be passed through a cavity formed between the housing and the manifold.
According to one aspect of the disclosure, and potentially in combination with other disclosed aspects of the disclosure, the gas inlet is a vacuum fitting.
According to one aspect of the disclosure, and potentially in combination with other disclosed aspects of the disclosure, a method of cooling a light source of a heat exchanger for a cleaning system includes directing a fluid through a fluid inlet fluidly coupled to a manifold of the heat exchanger; expelling the fluid from the fluid inlet and onto a second manifold end of the manifold on which the light source is coupled; generating an impingement cooling zone on the second manifold end of the manifold to cool the light source; directing the fluid through a manifold channel formed in the manifold; generating an annular convection zone within the manifold channel to cool the light source; and flushing the fluid from the heat exchanger via a fluid outlet fluidly coupled to the manifold.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A heat exchanger for a cleaning system, the heat exchanger comprising:
a housing;
a manifold coupled to and at least partially extending into the housing, the manifold further comprising:
a manifold body extending between a first manifold end and a second manifold end; and
a manifold channel formed within the manifold body;
a light source operatively coupled to the second manifold end of the manifold;
a fluid inlet fluidly coupled to the manifold channel; and
a fluid outlet fluidly coupled to the manifold channel;
wherein the fluid inlet is positioned to direct a fluid onto the second manifold end of the manifold to cool the light source.

2. The heat exchanger of claim 1, wherein the light source is a light emitting diode.

3. The heat exchanger of claim 1, wherein a plurality of flanges extend radially outward from the first manifold end of the manifold.

4. The heat exchanger of claim 3, wherein a rim is formed on the housing.

5. The heat exchanger of claim 4, wherein a plurality of fasteners extend through the plurality of flanges of the manifold and the rim of the housing to form a seal between the housing and the manifold.

6. The heat exchanger of claim 1, further comprising a gas inlet fluidly coupled to the housing and a gas outlet fluidly coupled to the housing, such that a gas may be passed through a cavity formed between the housing and the manifold.

7. The heat exchanger of claim 6, wherein the gas inlet is a vacuum fitting.

8. The heat exchanger of claim 6, wherein the gas outlet includes a sinter filter.

9. The heat exchanger of claim 1, wherein the fluid directed onto the second manifold end of the manifold further traverses the manifold channel to generate an annular convection zone to cool the light source.

10. The heat exchanger of claim 1, wherein the fluid inlet further includes a nozzle that directs fluid onto the second manifold end of the manifold.

11. The heat exchanger of claim 1, wherein the fluid inlet includes a fluid inlet diameter and the manifold channel includes a manifold channel diameter, and a ratio of the manifold channel diameter to the fluid inlet diameter is between 1.0-2.5.

12. The heat exchanger of claim 1, wherein the fluid inlet includes a fluid inlet diameter and the fluid inlet is positioned a distance from the second manifold end, and a ratio of the distance to the fluid inlet diameter is between 0.1-1.0.

13. A cleaning system comprising:
a chamber including a plurality of optical components;
a heat exchanger coupled to the chamber, the heat exchanger comprising:
a housing;
a manifold coupled to and at least partially extending into the housing, the manifold further comprising:
a manifold body extending between a first manifold end and a second manifold end; and
a manifold channel formed within the manifold body;
a light source fixedly coupled to the second manifold end of the manifold, such that the light source directs a light onto at least one of the plurality of optical components of the chamber;
a fluid inlet fluidly coupled to the manifold channel; and
a fluid outlet fluidly coupled to the manifold channel;
wherein the fluid inlet is positioned to direct a fluid onto the second manifold end of the manifold to cool the light source.

14. The cleaning system of claim 13, wherein the fluid inlet includes a fluid inlet diameter and the manifold channel includes a manifold channel diameter, and a ratio of the manifold channel diameter to the fluid inlet diameter is between 1.0-2.5.

15. The cleaning system of claim 13, wherein the fluid inlet includes a fluid inlet diameter and the fluid inlet is positioned a distance from the second manifold end, and a ratio of the distance to the fluid inlet diameter is between 0.1-1.0.

16. The cleaning system of claim 13, wherein the fluid directed onto the second manifold end of the manifold further traverses the manifold channel to generate an annular convection zone to cool the light source.

17. The cleaning system of claim 13, wherein the light source is a light emitting diode.

18. The cleaning system of claim 13, further comprising a gas inlet fluidly coupled to the housing and a gas outlet fluidly coupled to the housing, such that a gas may be passed through a cavity formed between the housing and the manifold.

19. The cleaning system of claim 18, wherein the gas inlet is a vacuum fitting.

20. A method of cooling a light source of a heat exchanger for a cleaning system, the method comprising:
directing a fluid through a fluid inlet fluidly coupled to a manifold of the heat exchanger,
expelling the fluid from the fluid inlet and onto a second manifold end of the manifold on which the light source is coupled;
generating an impingement cooling zone on the second manifold end of the manifold to cool the light source;
directing the fluid through a manifold channel formed in the manifold;
generating an annular convection zone within the manifold channel to cool the light source; and
flushing the fluid from the heat exchanger via a fluid outlet fluidly coupled to the manifold.
